(19) United States
(12) Patent Application Publication
(10) Pub. No.: US 2026/0194400 A1
(43) Pub. Date: Jul. 9, 2026

(54) SENSOR ELEMENT AND METHOD FOR MANUFACTURING A SENSOR ELEMENT

(71) Applicant: TDK Electronics AG, München (DE)

(72) Inventors: Anke Weidenfelder, Graz (AT); Jan Ihle, Raaba-Grambach (AT)

(21) Appl. No.: 19/117,352

(22) PCT Filed: Oct. 10, 2023
(86) PCT No.: PCT/EP2023/077998

§ 371 Date: Mar. 31, 2025

(30) Foreign Application Priority Data
Oct. 12, 2022 (DE) 102022126526.9

(51) Int. Cl. G01K 7/22; H01C 1/14; H01C 17/22; H01C 17/28

(52) U.S. Cl. CPC G01K 7/226; H01C 1/14; H01C 17/22; H01C 17/28

(57) ABSTRACT

A sensor element for measuring a temperature includes at least one carrier with a top side and a bottom side with an insulating layer formed on the top side of the carrier, at least two electrodes formed on the carrier at a distance from one another, at least one functional layer comprising a material with a temperature-dependent electrical resistance and arranged at least partially between the electrodes, at least two intermediate layers comprising an insulating material, and at least two contact pads for electrical contacting of the sensor element. The sensor element is adapted to be integrated directly into an electrical system as a discrete component. The sensor element has a small deviation range from a nominal resistance. At least one of the at least two electrodes is structured for setting the resistance value.

### FIELD OF THE INVENTION

The present invention relates to a sensor element, in particular a temperature sensor. The present invention further relates to a method for manufacturing at least one sensor element, preferably a temperature sensor.

### BACKGROUND OF THE INVENTION

In order to integrate passive components such as sensors, capacitors, protective components or heaters into electrical systems, the dimensions must be adapted for modern packaging designs, which are in the micrometer and even nanometer scale range. In order to achieve this degree of miniaturization, the components are deposited as thin films on carrier structures with electrical connections and described as discrete components. These novel components can be integrated among others into various printed circuit boards, MEMS (Micro Electro Mechanical System) or SESUB (Semiconductor Embedded in Substrate) structures.

The increasing demands on the accuracy of temperature measurement require tight tolerances in the resistance dispersion of such sensor elements. However, as structures become smaller, the manufacturing tolerances have an ever-increasing influence, as a result of which the resulting dispersion of the resistances exceeds the required tolerances. The resistance dispersion can only be reduced to a limited extent via the process control.

According to the state of the art, temperatures for monitoring and control in a wide variety of applications are mainly measured using ceramic thermistor elements (NTC), silicon temperature sensors (KTY), platinum temperature sensors (PRTD) or thermocouples (TC). NTC thermistors are the most widely used due to their low manufacturing costs. Another advantage over thermocouples and metallic resistance elements, such as Pt elements, is their distinct negative resistance-temperature characteristic.

SMD (“surface mounted device”) NTC temperature sensors, which are soldered on, are predominantly used in power modules. Alternatively, NTC chips are also used for low-power control modules, which are mounted on the bottom side using Ag sinter paste, soldering or bonding and the top side is contacted via a bonding wire.

Metallic electrodes must be applied for electrical contacting of the NTC ceramic. According to the current state of the art, thick-film electrodes made primarily from silver or gold pastes are applied using a screen printing process with subsequent firing.

Very small elements are required for the integration of electronic components in MEMS or SESUB structures, for example, and it must also be possible to integrate them using suitable contacting methods. Conventional assembly technologies for SMD designs or NTC chips cannot be used for this.

Document WO 2021/004957 A1, the content of which is incorporated by reference into this application, describes an NTC thin-film thermistor comprising at least one first thin-film electrode, at least one NTC thin-film and at least one second thin-film electrode.

Until now, thin-film NTC temperature sensors could not be manufactured with similarly tight tolerances as classic designs (SMD NTC and NTC chips).

### SUMMARY OF THE INVENTION

The object of the present invention is to describe a sensor element and a method for manufacturing a sensor element which solve the above problems.

This object is solved by a sensor element and a method for manufacturing a sensor element according to the independent claims.

According to one aspect, a sensor element is described. The sensor element is suitable for measuring a temperature. The sensor element is a temperature sensor. The sensor element is a thin-film NTC temperature sensor.

The sensor element has a very compact design. In particular, the sensor element is designed to be embedded as a discrete component directly in an electrical system. Preferably, the sensor element is designed for direct integration into a MEMS structure and/or a SESUB structure. For this purpose, the sensor element must have very small dimensions and must also be capable of being integrated using suitable contacting methods. For example, the sensor element has a maximum edge length of 1000 μm, preferably <800 μm, particularly preferably <500 μm. A thickness of the sensor element is <100 μm, preferably <80 μm, particularly preferably <50 μm.

The sensor element has at least one carrier. Preferably, the sensor element has exactly one carrier. The carrier has a carrier material, preferably silicon, silicon carbide or glass (silicate or borosilicate glass). Alternatively, the carrier can also consist of a ceramic material such as AIN, Si₃N₄ or Al₂O₂.

The carrier preferably has a rectangular base, but can also be square. In both cases, a maximum edge length of the carrier is 1000 μm, preferably <800 μm, ideally <500 μm.

The carrier has a top side and an bottom side. The top side is electrically insulating. In particular, an insulating layer is formed on the top side of the carrier. The insulating layer is arranged directly on the top side of the carrier. The insulating layer can be made up of one or more layers. For example, the insulating layer may comprise Al₂O₃, AlN, SiO₂ or Si₃N₄, or combinations of layers of these materials. A thickness of the insulating layer is ≤1.5 μm.

The sensor element further has at least two electrodes. The sensor element can of course also have more than two electrodes, for example four, six or eight electrodes.

The electrodes are preferably designed as thin-film electrodes. The electrodes can also be referred to as electrode layer. This is intended to express the fact that the electrodes represent individual layers of the sensor element. The terms electrode and electrode layer each refer to the same component of the sensor element.

The sensor element further has at least one functional layer. The sensor element can of course have more than one functional layer, for example two, three or four functional layers. In this case, the functional layers are arranged or stacked on top of each other transversely to a main direction of expansion of the sensor element.

The at least one functional layer is arranged on the carrier. The functional layer is at least partially formed on one of the at least two electrodes. In particular, the electrode (this can also be referred to below as “the lowest electrode”) is formed directly on the insulating layer. The functional layer is at least partially formed directly on the lowest electrode. Another of the at least two electrodes is at least partially arranged directly on the functional layer. The at least one functional layer is thus arranged at least partially between the electrodes (sandwich structure).

A thickness of the functional layer is between 50 nm and 1 μm, preferably between 100 nm and 500 nm, particularly preferably between 250 nm and 400 nm. The functional layer has a material (functional material) that has a special electrical characteristic. The functional layer has a material with a temperature-dependent electrical resistance. Preferably, the functional layer has an NTC ceramic. Preferably, the functional layer is a thin film with NTC characteristics.

The NTC ceramic is preferably based on an oxide material in the perovskite or spinel structure type. Alternatively, the functional layer can be based on a carbide or nitride material.

In particular, the following functional layers are possible:
Oxidic: for example perovskite (based on mixed crystals of the composition CaMnO₃, in which Ca can be completely or partially replaced by, for example, Y, Cr, Al or La) or spinel (based on mixed crystals of NiMn₂O₄, in which Ni and Mn can be completely or partially replaced with, for example, Fe, Co, Al);
b) Carbidic, for example (Si, Ti)C, hexagonal or cubic SiC;
c) Nitridic, for example (AI,Ti)N, CrN.

Thin layers of vanadium oxide are another alternative.

The sensor element further has at least two contact pads for electrically contacting the sensor element. Preferably, the sensor element has exactly two contact pads. The contact pads are directly electrically and mechanically connected to the electrodes.

Furthermore, the sensor element has at least two intermediate layers. The sensor element can also have more than two intermediate layers, for example four, five or six intermediate layers. The respective intermediate layer is insulating. In particular, the respective intermediate layer has an insulating material, for example Al₂O₃, AlN, SiO₂ or Si₃N₄.

By forming the intermediate layers, for example, electrical separation of the electrodes of different polarity in the contacted sensor element can be ensured. Furthermore, the intermediate layers serve to prevent the sensor element from having a stepped shape. In other words, the sensor element has a smooth surface (in particular due to the intermediate layers), in particular smooth side surfaces, i.e. side surfaces that are as free of steps as possible. As a result, electrical scattering effects can be effectively avoided.

The corresponding sensor elements have a narrow resistance tolerance. This means that the respective sensor element has a very small deviation range from a nominal resistance (nominal value of the resistance).

At least one of the at least two electrodes is structured to set the resistance value of the respective sensor element. The at least one electrode can be trimmed to adjust the resistance value. In particular, at least a partial area of this electrode is cut through for resistance adjustment. However, if the resistance of the component to be trimmed already corresponds to the target value, the structured/trimmable areas are not cut through.

By achieving a small deviation range from the nominal resistance, the sensor element has a very high accuracy in temperature measurement. Preferably, the corresponding sensor elements have a resistance tolerance that is comparable to the narrow resistance tolerance of classic designs such as SMD NTCs or NTC chips.

According to an embodiment, the sensor element has a top side and a bottom side. The top and bottom sides are arranged opposite each other and are connected to each other by side surfaces of the sensor element. The bottom side of the sensor element refers to the side that is closed off by the carrier. In particular, the bottom side of the sensor element is formed by the carrier.

The sensor element has a bottom/lowest and a top/uppermost electrode. The uppermost electrode is the electrode closest to the top side of the sensor element. The lowest electrode is the electrode closest to the bottom side of the sensor element. The lowest electrode is formed directly on the insulating layer. The lowest electrode does not have to cover the insulating layer completely. A partial area of the insulating layer is preferably free of an electrically conductive material of the lowest electrode.

The electrode closest to the top side of the sensor element (i.e. the uppermost electrode) is structured to set the resistance value. This results in areas on the uppermost electrode that can be trimmed. In particular, the top/uppermost electrode has one or more trimmable areas. A trimmable area is preferably cut through to adjust the resistance value of the sensor element, preferably using a laser (laser trimming). Several trimmable areas can also be cut through.

Cutting trimmable areas results in a change in the total electrode area and therefore in the resistance. This allows the resistance tolerance of the final sensor elements to be optimized.

According to an embodiment, the respective intermediate layer is arranged in such a way that electrical and mechanical contact between electrodes and contact pads of different polarity is prevented in the final contacted sensor element. In other words, the intermediate layer is designed and arranged as a separating layer or buffer between electrodes or contact pads of different polarity. A thickness (i.e. expansion perpendicular to a main direction of expansion of the sensor element) of the respective intermediate layer can be greater than or equal to a thickness of the respective electrode.

Preferably, the respective intermediate layer is designed as an extension of the respective electrodes along the main direction of expansion of the sensor element. In other words, the intermediate layer extends the expansion of the electrode parallel to the carrier or parallel to the functional layer. This ensures that each (electrode) layer has the same extension along the carrier. This results in a smooth side surface of the sensor element that is as free as possible from edges or steps. Scattering effects in the overlap areas of the electrodes on the outer areas due to diagonal current paths with different path lengths are avoided in this way.

Alternatively or additionally, the respective intermediate layer is arranged in such a way that direct contact between the at least one functional layer and the contact pads is prevented. The intermediate layer can therefore be adapted and arranged as a separating layer or buffer between the at least one functional layer and the contact pads.

The electrodes have an overlap area. In the overlap area, the electrodes are formed on top of each other. The at least one functional layer is designed such that expansion of the functional layer beyond the overlap area is prevented. In other words, the functional layer is only arranged within the overlap area. The functional layer does not protrude out of the overlap area. Instead, an intermediate layer is provided in an area between the functional layer and the contact pads.

This intermediate layer not only serves to mechanically/electrically separate the contact pads and functional layer, but also ensures that the individual layers (electrodes, functional layer) have the same extension parallel to the carrier. The intermediate layers therefore extend the functional layer and the electrodes so that all layers have the same extension parallel to the carrier. This ensures that the side surface of the sensor element is as free as possible from edges or steps. Scattering effects are effectively avoided.

According to one embodiment, the respective intermediate layer is formed circumferentially around the at least one functional layer. The respective intermediate layer can also be formed in a U-shape around the respective electrode. This allows the respective layer to be effectively protected from external influences.

According to one embodiment, the sensor element further has an insulation. The insulation protects the sensor element from external influences. The insulation is designed and arranged in such a way that it completely envelops at least a partial area of the sensor element. Preferably, at least the at least one functional layer and the at least two intermediate layers are completely circumferentially surrounded by the insulation. Furthermore, at least a partial area of the at least two electrodes is enveloped by the insulation. Preferably, the electrodes are completely surrounded by the insulation. The contact pads are designed in such a way that they protrude from the insulation on a top side of the sensor element for electrical contacting of the sensor element.

According to an embodiment, the sensor element has a first or upper section. The sensor element also has a second or lower section. The first section has a width B1. The second section has a width B2. In this context, width means the extent of the respective section along the main direction of expansion of the sensor element. In particular, the width means the extension parallel to the carrier.

The two sections are arranged one above the other. In particular, the first section comprises the functional layer, the electrodes, the intermediate layers and the contact pads. The first section can also include the insulation. The second section comprises in particular the carrier and the insulating layer. A side surface, preferably all side surfaces of the first section and/or the second section are free of steps. In other words, the outer surfaces of the respective section are smooth.

The sections are formed in such a way that B1≤B2. In other words, the first section can be the same width as the second section. In this case, there is no step/edge at all on the side surface of the sensor element. Alternatively, the width of the first section can also be less than the width of the second section. In this case, a (single) step/edge is formed on the side surface of the sensor element at the transition between the first and second section.

According to a further aspect, a method for manufacturing at least one sensor element is described. It should be noted that the method preferably produces a plurality of sensor elements, for example 20000 sensor elements, in parallel and finally separates them from one another. For the sake of simplicity, reference is made below essentially to a sensor element where this appears appropriate.

Preferably, the method is used to produce the sensor element described above. The respective sensor element has only a small deviation range from a nominal resistance. The sensor elements produced by the method have a narrow resistance tolerance as a whole.

All properties disclosed in relation to the sensor element or the method are also correspondingly disclosed in relation to the respective other aspect and vice versa, even if the respective property is not explicitly mentioned in the context of the respective aspect. The method comprises the following steps:
A) Providing a carrier material to form a carrier. The carrier serves to mechanically stabilize the sensor element. Preferably, the carrier material has Si, SiC or glass. Alternatively, the carrier material can also have AIN or Al₂O₃.
B) Forming an insulating layer on a top side of the carrier. The insulating layer may comprise Al₂O₃, AlN, SiO₂ or Si₃N₄, or combinations of layers of these materials. Preferably, the insulating layer completely covers the top side of the carrier. If the carrier material is electrically insulating, the formation of the insulating layer according to step B) can also be omitted (optional step, depending on the material).
C) Application of a first electrode (bottom/lowest electrode) on the insulating layer/the top side of the carrier. The electrode material is deposited by a PVD (“physical vapor deposition”) process, a CVD (“chemical vapor deposition”) process or galvanically. Alternatively, deposition can also be carried out using an ALD (atomic layer deposition) process. Preferably, the electrode is deposited on only a partial area of the insulating layer. In other words, a partial area of the insulating layer/carrier remains free of the metallic material of the lowest electrode.
D) Application of at least one intermediate layer to the insulating layer. In particular, the intermediate layer is applied to the partial area that has remained free of the metallic material of the lowest electrode. The intermediate layer and the lowest electrode can have the same thickness/height. In this case, the intermediate layer and the lowest electrode form a plane. Alternatively, the intermediate layer can also be thicker.
E) Application of at least one functional layer to at least a partial area of the lowest electrode. This is done, for example, by sputtering or a spin coating process.

The functional layer can be formed on the plane formed by the intermediate layer and the lowest electrode. Alternatively, the functional layer can also be formed only on a partial area of this plane. In this case, an additional intermediate layer is formed in a further step as a buffer between the functional layer and the contact pads described above.
F) Application of at least one further electrode. The electrode is applied directly to at least a partial area of the functional layer. In other words, a partial area of the functional layer can remain free of the metallic material of the electrode.
G) Application of at least one further intermediate layer. The intermediate layer can be formed in the partial area of the functional layer that remained free of the metallic material of the additional electrode. Alternatively or additionally, an intermediate layer can be formed as a buffer between the functional layer and the contact pads described above.
H) Structuring of at least one of the electrodes to form at least one trimmable area for resistance adjustment. This can be done, for example, by wet chemical etching or dry etching or laser structuring. Preferably, the uppermost electrode is structured as described above.
I) Forming contact pads for electrical contacting of the sensor element. In the final contacted sensor element, the electrodes of the same polarity are connected vertically (i.e. in the stacking direction) to a metallic material. Preferably, the contact pads comprise metals such as Cu, Al or Au.

The functional layer is then measured. The initial tolerance range of the resistance value of the sensor elements is determined so that the resistance of the respective sensor element can later be set to the nominal value.
J) Adjusting the resistance value by trimming the at least one structured electrode. Trimming is preferably carried out using a laser. The resistance value is set to a predetermined nominal value. By precisely adjusting the resistance value of the respective sensor element, the finished sensor elements as a whole have a very narrow resistance tolerance.

According to one embodiment, an insulation is further formed on at least a partial area of a surface of the sensor element. This protects the sensor element from external influences. This step can be carried out before or after step J). If the insulation is formed before step J), the structured electrode remains free of the insulation so that trimming can be carried out afterwards.

### BRIEF DESCRIPTION OF THE DRAWINGS

The drawings described below are not to be understood as true to scale. Rather, individual dimensions may be enlarged, reduced or even distorted for better representation.

Elements that are identical or have the same function are designated with the same reference signs.

It shows:

FIG. 1 a sensor element according to the state of the art,

FIG. 2 a cross-section of a sensor element according to a first embodiment,

FIG. 3 a cross-section of a sensor element according to a further embodiment,

FIG. 4 a cross-section of a sensor element according to a further embodiment,

FIGS. 5a to 5c a top view of individual components of the sensor element according to FIG. 4,

FIG. 6 a cross-section of a sensor element according to a further embodiment,

FIG. 7 a top view of the top side of the sensor element with the trimmable electrodes.

### DETAILED DESCRIPTION

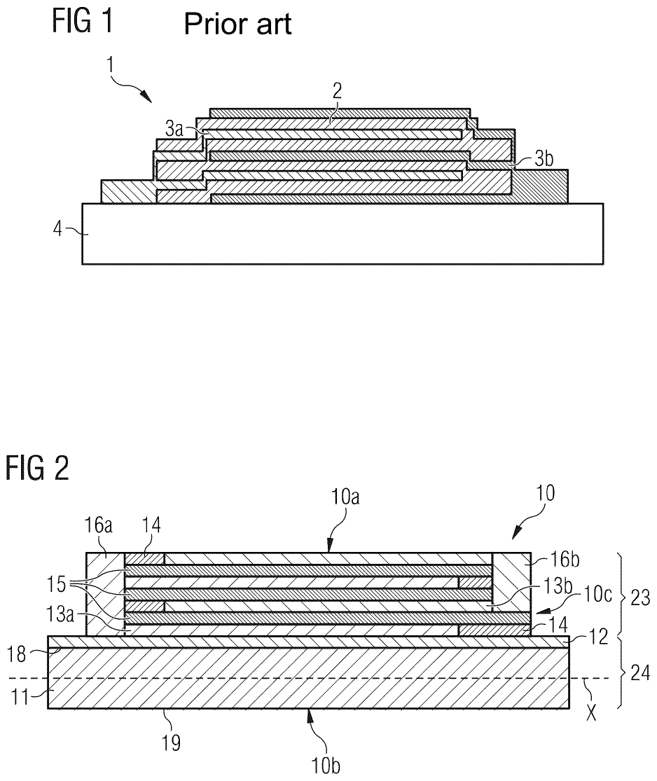

FIG. 1 shows a representation of a sensor element 1 according to the state of the art. The sensor element 1 is a multi-layer NTC thin-film temperature sensor and has a carrier 4, first and second electrodes 3a, 3b and functional layers 2.

The sensor element 1 serves to illustrate a basic structure of the sensor element 10 described below. Reference is made to document WO 2021/004957 A1 with regard to the essential features of the sensor element 1 according to FIG. 1.

The design of sensor element 1 has some disadvantages. The stepped design makes process control more difficult. In particular, the formation of electrodes 3a, 3b can result in insufficient edge coverage and therefore poor contacting. Furthermore, the staircase design causes electrical scattering effects in the overlap areas on the outer areas due to diagonal current paths of different path lengths. With path lengths that are shorter than the distance from electrode 3a, 3b to functional layer 2, hotspots occur locally due to increased voltage drop at the thin point. This makes low resistance scattering more difficult and the scattering of the components is outside the usual scattering range.

The disadvantages mentioned are reduced or eliminated in the embodiments of the sensor element 10 described below.

FIG. 2 shows a cross-section of a sensor element 10 according to a first embodiment. The sensor element 10 is a thin-film NTC temperature sensor. The sensor element 10 has a top side 10a and a bottom side 10b as well as side surfaces 10c.

The sensor element 10 is designed for direct integration into a MEMS structure and/or a SESUB structure. For this purpose, the sensor element 10 is designed to be very compact. A maximum edge length (i.e. the dimension along a main direction of expansion X) is 1000 μm, preferably <800 μm, particularly preferably <500 μm. A thickness or height of the sensor element 10 (i.e. the expansion in a direction perpendicular to the main expansion direction X) is <100 μm, preferably <80 μm, particularly preferably <50 μm. Due to its small dimensions, the sensor element 10 is ideally suited for being embedded as a discrete component directly in a MEMS/SESUB structure.

The sensor element 10 has a carrier 11. The carrier 11 preferably comprises silicon, silicon carbide or glass (silicate or borosilicate glass). Alternatively, the carrier 11 can also have AlN, Si₃N₄ or Al₂O₃. The carrier 11 can have a rectangular or square base. As described above, a maximum edge length of the carrier 11 is 1000 μm in both cases, advantageously <800 μm, ideally <500 μm.

The carrier 11 has a top side 18 and a bottom side 19. An insulating layer 12 is formed on the top side 18, which completely covers the top side 18 of the carrier. A thickness d of the insulating layer 12 (see also FIG. 4) is ≤1.5 μm. The insulating layer 12 can be made up of one or more layers and can comprise, for example, Al₂O₃, AlN, SiO₂ or Si₃N₄, or combinations of layers of these materials.

In this embodiment, the sensor element 10 further has three functional layers 15. The sensor element 10 can of course also have only one functional layer 15 or more than three functional layers 15. Depending on the number of functional layers 15, different resistances of the sensor element 10 can be realized. The functional layers 15 are arranged or stacked on top of each other. The functional layers 15 are connected in parallel.

A thickness or height of the respective functional layer 15 is between 50 nm and 1 μm, preferably between 100 nm and 500 nm, particularly preferably between 250 nm and 400 nm. The functional layers 15 have a material with a special electrical characteristic. The respective functional layer 15 has an NTC ceramic. Preferably, the respective functional layer 15 is a thin film with NTC characteristics.

Preferably, the functional layer 15 is based on an oxide material in the perovskite or spinel structure type. Alternatively, the functional layer 15 can be based on a carbide or nitride material. In particular, the following functional layers 15 are conceivable:
Oxidic: for example perovskite (based on mixed crystals of the composition CaMnO₃, in which Ca can be completely or partially replaced by, for example, Y, Cr, Al or La) or spinel (based on mixed crystals of NiMn₂O₄, in which Ni and Mn can be completely or partially replaced with, for example, Fe, Co, Al);
b) Carbidic, for example (Si, Ti)C, hexagonal or cubic SiC;
c) Nitridic, for example (AI, Ti)N, CrN.

Thin layers of vanadium oxide are another alternative.

In this embodiment, the sensor element 10 further has several electrodes or electrode layers 13a, 13b, in particular four electrodes 13a, 13b. Of course, the sensor element 10 can also have only two electrodes 13a, 13b or more than four electrodes 13a, 13b. The electrodes 13a, 13b have opposite polarity (as soon as the sensor element 10 is finally contacted). The electrodes 13a, 13b of opposite polarity can also be referred to as first electrodes 13a and second electrodes 13b. The electrodes 13a, 13b can be single-layered or multi-layered and have, for example, Cu, Au, Ni, Cr, Ag, Ti, Ta, W, Pd or Pt. The electrodes 13a, 13b are designed as thin-film electrodes.

An electrode 13a, 13b (hereinafter referred to as the lowest electrode) is formed directly on the insulating layer 12. The lowest electrode does not completely cover the insulating layer 12, as can be seen from FIG. 2. Rather, a strip-shaped area of the insulating layer 12 remains free of the electrically conductive material of the lowest electrode, as will be explained in more detail below.

A (lowest) functional layer 15 is formed directly on the lowest electrode 13a, 13b. The lowest electrode does not necessarily have to be completely covered by the functional layer 15. A further electrode 13a, 13b is arranged at least partially directly on the functional layer 15. This layered structure is continued. In particular, a functional layer 15 is always arranged at least partially between two electrodes 13a, 13b.

The respective electrodes 13a, 13b are connected vertically to each other on the side surfaces 10c of the sensor element 10. These connections serve as contact pads 16a, 16b for the sensor element 10, which can be contacted by means of wire bonding, for example. This results in a parallel connection of the individual functional layers 15. The contact pads 16a, 16b are directly electrically and mechanically connected to the electrodes 13a, 13b. Furthermore, the contact pads 16, 16b in this embodiment are in direct contact with the functional layers 15. The contact pads can have Cu, Au, Ni, Cr, Ag, Ti, Ta, W, Pd or Pt.

Furthermore, the sensor element 10 has four intermediate layers 14 in this embodiment. The sensor element 10 can also have only two intermediate layers 14 (in this case, the sensor element 10 has exactly one functional layer 15 and exactly two electrodes 13a, 13b; not explicitly shown), or the sensor element 10 can have more than four intermediate layers 14. The respective intermediate layer 14 has an insulating material. The respective intermediate layer 14 has, for example, Al₂O₃, AlN, SiO₂ or Si₃N₄.

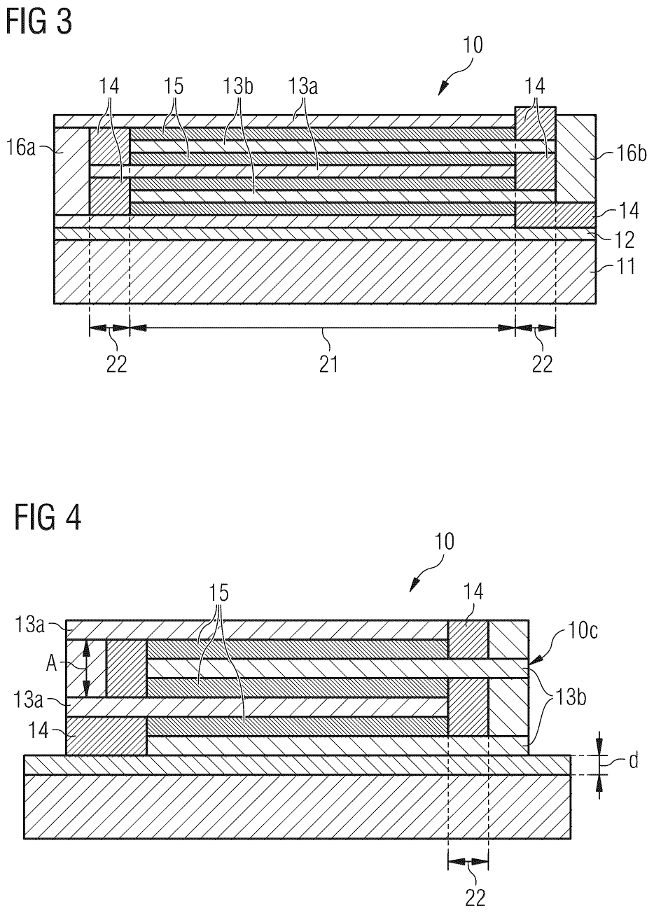

In this embodiment, a thickness or height (i.e. the expansion perpendicular to the main direction of expansion X) of the respective intermediate layer 14 is as large as a thickness or height of the respective electrodes 13a, 13b. In other words, the electrodes 13a, 13b and the intermediate layers 14 are the same height. However, the thickness/height of the intermediate layer 14 can also be greater than the thickness/height of the electrodes 13a, 13b (see FIGS. 3, 4, and 6). For example, the intermediate layer 14 can extend perpendicular to the main direction of expansion X across several layers of the sensor element 10, as will be explained in more detail below.

In the embodiment according to FIG. 2, the respective intermediate layer 14 is formed as an extension of the respective electrode 13a, 13b along the main direction of expansion X of the sensor element 10 (or parallel to the top side 18 of the carrier 11). For example, it can be seen from FIG. 2 that the lowest electrode does not completely cover the insulating layer 12. Rather, there is an area on the insulating layer 12 in the form of a strip that is not metallized, as already mentioned above.

This free area is filled with the insulating material of the intermediate layer 14. The intermediate layer 14 therefore continues the lowest electrode. The lowest functional layer 15 is formed on these two layers (lowest electrode and intermediate layer 14) or on the plane formed by these layers.

A second electrode 13b is then formed on the lowest functional layer 15, which does not completely cover the functional layer 15 on the left-hand side in FIG. 2. This free area is again covered with an intermediate layer 14. Similarly, an intermediate layer 14 continues or extends the other electrodes 13a, 13b in the X direction.

The individual layers of the sensor element 10 (in this embodiment the electrodes 13a, 13b) are filled by the insulating intermediate layers 14. This reduces a staircase shape of the sensor element 10 compared to the prior art according to FIG. 1, as will be explained in more detail below:

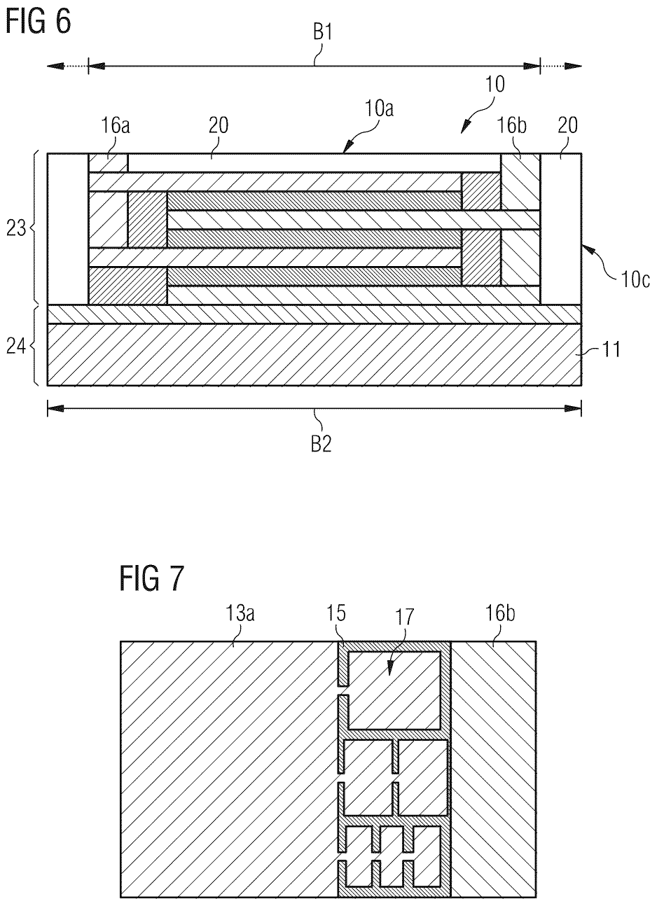

The sensor element 10 has a first section 23 and a second section 24 (see in particular FIG. 6). The sections 23 and 24 are arranged one above the other. The first section 23 has a width B1 and the second section 24 has a width B2. In this context, width means the extent of the respective section 23, 24 along the main direction of expansion X (X-direction). In this embodiment is B1<B2. In principle, however, B1=B2 is also possible (see, for example, FIGS. 3 and 6).

The first section 23 comprises in particular the functional layers 15, the electrodes 13a, 13b, the intermediate layers 14 and the contact pads 16a, 16b. The second section 24 comprises in particular the carrier 11 and the insulating layer 12.

As can be seen in FIG. 2, a side surface of the first section 23 is completely free of edges or steps. The same applies to the side surface of the second section 24. A step is only present in a transition area between the first section 23 and the second section 24. In other words, the outer surfaces of the respective section 23, 24 are smooth. This is achieved by the fact that all layers of the first section 23 have the same extension along the X-axis, as individual layers are filled with the intermediate layers 14.

The formation of the intermediate layers 14 and the resulting reduction in the step shape of the sensor element 10 effectively reduces electrical scattering effects. In addition, the possibility of hot spots forming is reduced.

All of the sensor elements 10 have a narrow resistance tolerance. This means that the respective sensor element 10 has a very small deviation range from the nominal resistance.

To adjust the resistance value of the respective sensor element 10, one of the electrodes 13a, 13b is structured (see FIG. 7). Preferably, the uppermost electrode, i.e. the one of the electrodes 13a, 13b which is closest to the top side 10a of the sensor element 10, is structured. This means that the electrode has areas that can be trimmed (see trimmable areas 17 in FIG. 7). These areas can be cut through with a laser, resulting in a change in the total area of the electrode and thus in the resistance.

By achieving a narrow resistance tolerance of the sensor elements 10, the sensor elements 10 have a very high accuracy in temperature measurement. Preferably, the sensor elements 10 have a resistance tolerance that is comparable to the narrow resistance tolerance of classic designs such as SMD NTCs or NTC chips.

In the embodiment described in connection with FIG. 2, each functional layer 15 has an additional contact to the contact pads 16a, 16b, which can still lead to scattering effects at the outer areas of the sensor element 10 due to diagonal current paths with different path lengths. To further eliminate scattering effects, in the embodiment shown in FIG. 3, the respective functional layer 15 is designed such that it is only located in an overlap area 21 formed by both electrodes 13a, 13b.

As can be seen in FIG. 3, the electrodes have the overlap area 21. In the overlap area 21, the electrodes 13a, 13b are layered on top of each other. In contrast to the embodiment shown in FIG. 2, the functional layers 15 are now designed in such a way that they do not extend beyond the overlap area 21. In other words, the width of the functional layers 15 is reduced compared to the functional layers according to FIG. 2.

In an area 22 between the respective functional layer 15 and the contact pads 16a, 16b, an intermediate layer 14 is formed for this purpose between the respective functional layer 15 and the contact pad 16a, 16b. This intermediate layer 14 closes the gap that occurs because the functional layers 15 no longer extend beyond the overlap area 21.

Consequently, in this embodiment, the intermediate layers 14 extend not only the electrodes 13a, 13b, but also the functional layers 15. This ensures that the side surface 10c of the sensor element 10 is as free as possible from edges or steps. Furthermore, a width of the individual layers of the first section 23 in this embodiment is chosen such that a step between the first and second sections 23, 24 is omitted (i.e. B1=B2). Scattering effects are effectively avoided.

The thickness of the intermediate layer can be greater than the thickness of an individual electrode 13a, 13b/electrode layer. In particular, the respective intermediate layer 14 extends here perpendicular to the main direction of expansion X across several layers of the sensor element 10. Thus, the maximum thickness or height of the intermediate layer 14 can reach the total height of two functional layers 15 plus one electrode layer 13a, 13b, as can be seen in FIG. 3. In other words, the intermediate layer 14 in the finally contacted sensor element 10 is filled up in maximum from one electrode 13a, 13b of one polarity up to the next electrode 13a, 13b of the same polarity in the stacking direction. The maximum thickness of the intermediate layer 14 therefore corresponds to the distance A between two electrodes 13a, 13b of the same polarity (see also FIG. 4).

With regard to all other features of the sensor element 10, reference is made to the description in connection with FIG. 2.

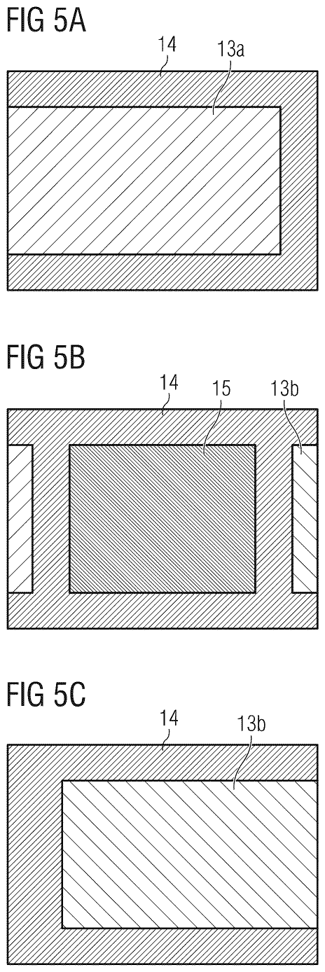

FIGS. 4 and 5a to 5c show a sensor element 10 and individual components thereof according to a further embodiment.

In the two embodiments described above according to FIGS. 2 and 3, two of four side surfaces of the individual layers are exposed and therefore not protected. To enable a protection of these the insulating intermediate layers 14 in the embodiment as shown in FIG. 4, are designed circumferentially around the functional layer 15, respectively (see also FIG. 5b). With other words, with the exception of a top side and a bottom side of the functional layer 15, all surfaces of the respective functional layer 15 are enveloped by the insulating material of the intermediate layer 14.

In order to avoid a staircase-shaped design of the sensor element 10 the intermediate layers 14 are further deposited around each electrode 13a, 13b in a U-shape (FIGS. 5a and 5c). FIGS. 5a and 5c show that, with the exception of a top side and a bottom side as well as one side surface of the of the respective electrode 13a, 13b, the further side surfaces of the electrodes 13a, 13b are completely surrounded by the insulating material of the intermediate layer 14. In other words, three out of four side surfaces of the respective electrode 13a, 13b are embedded in the intermediate layer 14.

With regard to all other features of the sensor element 10, reference is made to the description in connection with FIG. 2.

FIG. 6 shows a cross-section of the sensor element 10 according to a further embodiment.

Here, the sensor element 10 is at least partially surrounded by insulation 20. In particular, at least the side surface 10c of the sensor element 10 (without carrier 11) is preferably completely enveloped by the insulation 20. In particular, the insulation 20 encloses the electrodes 13a, 13b (an exception to this can be the uppermost electrode, as described below), the functional layers 15 and the intermediate layers 14 as well as parts of the contact pads 16a, 16b. In this way, these components of the sensor element 10 are protected from external influences. In principle, it is also possible to envelop the insulating layer 12 and the carrier 11 (not explicitly shown).

Since the uppermost electrode has the trimmable areas 17 (see FIG. 7), which (can) be cut through depending on the nominal value of the resistance, the uppermost electrode must be freely accessible for laser trimming. Therefore, there are two possible designs for the insulation 20 in the area of the top side 10a of the sensor element 10:
The uppermost electrode can remain completely free of the insulation 20 so that it is accessible at all times for resistance adjustment (not explicitly shown).
Alternatively, the insulation on the top side 10a of the sensor element 10 can also be formed after trimming. For example, after trimming, a polymer layer, an oxide, nitride or ceramic layer, a thin glass layer or a combination of layers can be formed as insulation 20 on the uppermost/structured electrode.

As can be seen from FIG. 6, the contact pads 16a, 16b protrude from the insulation 20 at the top side 10a of the sensor element in every possible embodiment in order to enable electrical contacting of the sensor element 10. For this purpose, the contact pads 16a, 16b are constructed higher in this embodiment. In particular, a top side of the contact pads 16a, 16b is not in one plane with a top side of the uppermost electrode.

With regard to all other features of the sensor element 10, reference is made to the description in connection with FIG. 2.

A method for manufacturing the sensor element 10 is described below. In particular, the method is used to manufacture a plurality of sensor elements 10 in accordance with one of the embodiments described above (see FIGS. 2 to 7). For the sake of simplicity, only one sensor element 10 is referred to below, where appropriate.

All features described in connection with the sensor element 10 also apply to the method and vice versa.

The method comprises the following steps:
A) Providing a carrier material for forming the carrier 11. Preferably, the carrier material has Si, SiC or glass. Alternatively, the carrier material can also have AlN, Si₃N₄ or Al₂O₃.
B) Forming the insulating layer 12 on the top side 18 of the carrier 11. The insulating layer 12 may comprise Al₂O₃, AlN, SiO₂ or Si₃N₄, or combinations of layers of these materials. Preferably, the insulating layer 12 is deposited such that it completely covers the top side 18 of the carrier 11.

The insulating layer 12 can be required as a flat base surface in order to form the further layers (electrodes 13a, 13b, intermediate layers 14, functional layers 15) on it. If the top side 18 of the carrier 11 is flat enough and/or the carrier 11 itself is made of an insulating material, the formation of the insulating layer 12 according to step B) can also be omitted (optional step).
C) Application of a first electrode 13a, 13b (lowest electrode). The electrode 13a, 13b is deposited by a PVD, ALD or CVD process or by electroplating. Preferably, the electrode 13a, 13b is deposited only on a partial area of the insulating layer 12. A strip-shaped area of the insulating layer 12 remains free of electrode material so that an intermediate layer 14 can subsequently be formed in this free area.
D) Application of at least one intermediate layer 14 to the insulating layer 12 to extend the electrode 13a, 13b. The intermediate layer 14 has an insulating material and is formed in the partial area (free area) of the insulating layer 12 that remained free of the metallic material of the electrode 13a, 13b. Intermediate layer 14 and the lowest electrode can form a plane, i.e. can have the same height (FIG. 2). Alternatively, the intermediate layer 14 can also be formed higher than the electrode 13a, 13b (FIGS. 3, 4, 6).
E) Application of at least one functional layer 15. This is done, for example, by sputtering or a spin coating process and at least one temperature process at T>500° C. during and/or after the deposition of the respective layer. The functional material has an NTC ceramic based on an oxide material of the perovskite or spinel structure type. Alternatively, the functional material can also be based on a carbide or nitride material. In a further alternative, the functional material comprises or consists of thin layers of vanadium oxide.

The functional layer 15 is formed, for example, on the plane formed by the intermediate layer 14 and the lowest electrode (see FIG. 2). The functional layer 15 can either be deposited on the entire lowest electrode 13a, 13b (FIG. 2), or the functional layer 15 is not formed up to the edge of the lowest electrode. This means that on the opposite side of the intermediate layer 14 (left in FIG. 2), the lowest electrode is not covered up to the edge. In this case, a further intermediate layer 14 is then formed, which is formed on the area of the lowest electrode that remained free (from the functional layer 15) (FIGS. 3, 4, 6).
F) Application of at least one further electrode 13a, 13b. The electrode 13a, 13b is deposited by a PVD, ALD or CVD process or by electroplating. The further electrode 13a, 13b is formed directly on the functional layer 5. The further electrode 13a, 13b can, for example, only be formed on a partial area of the functional layer 15 (see embodiment according to FIG. 2).
G) Application of at least one further intermediate layer 14. The intermediate layer 14 has an insulating material and is formed, for example, in the partial area of the functional layer 15 that remained free of the metallic material of the further electrode 13a, 13b. Alternatively or additionally, intermediate layers 14 can be formed in the area between functional layer 15 and contact pads 16a, 16b. This is done subsequently to step I).
H) Structuring of at least one of the electrodes 13a, 13b to form at least one trimmable area 17 for resistance adjustment. This can be done, for example, by wet chemical etching or dry etching or laser structuring. Preferably, the upper-most electrode is structured as described above.
I) Forming contact pads 16a, 16b for electrical contacting of the sensor element 10. In particular, in the fully contacted sensor element 10, the electrodes 13a, 13b of the same polarity are connected vertically (i.e. in the stacking direction) with a metallic material. Preferably, the contact pads 16a, 16b have metals such as Cu, Al or Au.

The functional layer 15 is then measured. The initial tolerance range of the resistance value of all of the manufactured sensor elements 10 is determined so that the resistance of the respective sensor element 10 can subsequently be set to the nominal value.
J) Adjusting the resistance value by trimming the at least one structured electrode 13a, 13b. Trimming is preferably carried out using a laser. The resistance value is set to a predetermined nominal value. Due to the precise adjustment of the resistance value, the finished sensor elements 10 have a very narrow resistance tolerance. To set the resistance value, the previously described structured/trimmable areas 17 are at least partially cut through.
K) Forming the insulation 20 on at least a partial area of a surface of the sensor element 10.

Step K) can also be carried out before step J). In this case, the uppermost electrode remains free of the insulation 20 so that trimming can be carried out afterwards.

In addition to the aforementioned process steps, the sensor element 10 can be subjected to a sintering process in a further process step.

The carrier can then be thinned by means of a grinding or etching process.

The description of the objects specified here is not limited to the individual special embodiments. Rather, the features of the individual embodiments can be combined with one another as desired, insofar as this makes technical sense.

### LIST OF REFERENCE SIGNS

1 Sensor element
2 Functional layer
3a First electrode
3b Second electrode
4 Carrier
10 Sensor element
10a Top side of the sensor element
10b Bottom side of the sensor element
10c Side surface of the sensor element
11 Carrier
12 Insulating layer
13a Electrode/electrode layer
13b Electrode/electrode layer
14 Intermediate layer
15 Functional layer
16a Contact pad
16b Contact pad
17 Trimmable area
18 Top side of the carrier
19 Bottom side of the carrier
20 Insulation
21 Overlap area
22 Area
23 First section
24 Second section
d Thickness of the insulating layer
B1 Width of the first section
B2 Width of the second section
X Main direction of expansion
A Distance

1-32. (canceled)

33. A sensor element for measuring a temperature, the sensor element comprising:
at least one carrier with a top side and a bottom side, wherein an insulating layer is formed on the top side of the carrier;
at least two electrodes formed on the carrier at a distance from one another;
at least one functional layer comprising a material with a temperature-dependent electrical resistance, the at least one functional layer being arranged at least partially between the electrodes;
at least two intermediate layers comprising an insulating material; and
at least two contact pads for electrical contacting of the sensor element;
wherein the sensor element is adapted to be integrated directly into an electrical system as a discrete component,
wherein the sensor element has a small deviation range from a nominal resistance, and
wherein at least one of the at least two electrodes is structured for setting the resistance value.

34. The sensor element of claim 33, wherein the sensor element has a top side and a bottom side, and wherein the electrode of the at least two electrodes that is closest to the top side of the sensor element is structured for setting the resistance value.

35. The sensor element of claim 34, wherein the electrode of the at least two electrodes that is closest to the top side of the sensor element has trimmable areas.

36. The sensor element of claim 33, wherein at least one of the at least two intermediate layers is arranged to prevent direct contact between the at least one functional layer and the at least two contact pads.

37. The sensor element of claim 33, wherein at least one of the at least two intermediate layers is formed as an extension of the at least two electrodes along a main direction of expansion of the sensor element.

38. The sensor element of claim 33, wherein at least one of the at least two intermediate layers is formed in an area between the at least one functional layer and one of the at least two contact pads.

39. The sensor element of claim 33, wherein the at least two electrodes have an overlap area in which the at least two electrodes are formed one above the other, and wherein the at least one functional layer is formed in such a way that expansion of the at least one functional layer beyond the overlap area is prevented.

40. The sensor element of claim 33, wherein at least one of the at least two intermediate layers is formed circumferentially around the at least one functional layer.

41. The sensor element of claim 33, wherein at least one of the at least two intermediate layers is formed in a U-shape around one of the at least two electrodes

42. The sensor element of claim 33, wherein a thickness of at least one of the at least two intermediate layers is greater than or equal to a thickness of at least one of the at least two electrodes.

43. The sensor element of claim 33, further comprising an insulation, wherein at least the at least one functional layer and the at least two intermediate layers are completely circumferentially surrounded by the insulation, and wherein at least a partial area of the at least two electrodes is surrounded by the insulation.

44. The sensor element of claim 43, wherein at least one of the at least two contact pads protrude from the insulation on a top side of the sensor element.

45. The sensor element of claim 33, wherein one of the at least two electrodes is formed below the at least one functional layer and wherein another of the at least two electrodes is formed above the at least one functional layer.

46. The sensor element of claim 33, wherein the sensor element has a first section and a second section, the first section including the at least one functional layer, the at least two electrodes, the at least two intermediate layers, and the at least two contact pads, the second section including the at least one carrier and the insulating layer, the first section having a width B1 and the second section having a width B2, wherein B1≤B2.

47. The sensor element of claim 46, wherein (i) a side surface of the first section is free of steps, (ii) a side surface of the second section is free of steps, or (iii) both (i) and (ii).

48. The sensor element of claim 33, wherein a lowest electrode of the at least two electrodes is formed directly on the insulating layer.

49. The sensor element of claim 48, wherein a partial area of the insulating layer is free of an electrically conductive material of the lowest electrode.

50. The sensor element of claim 49, wherein at least one of the at least two intermediate layers is formed in the partial area of the insulating layer that is free of the electrically conductive material.

51. The sensor element of claim 33, wherein at least one of the at least two electrodes is designed as a thin-film electrode.

52. The sensor element of claim 33, wherein the at least one functional layer is a thin film with negative temperature coefficient (NTC) properties.

53. The sensor element of claim 33, wherein the carrier comprises silicon, silicon carbide, glass, Si₃N₄, AlN, GaN, A₂lO₃, or any combination thereof.

54. The sensor element of claim 33, wherein the at least one functional layer comprises an NTC ceramic based on an oxidic material having a perovskite structure or a spinel structure, or wherein the functional layer comprises an NTC ceramic based on a carbide material or a nitride material.

55. The sensor element of claim 33, wherein the at least two electrodes are single-layered or multilayered, and comprise one material or a combination of materials selected from Cu, Au, Ni, Cr, Ag, Ti, Ta, W, Pd, and Pt.

56. The sensor element of claim 33, wherein the at least two contact pads are single-layered or multi-layered and comprise one material or a combination of materials selected from Cu, Au, Ni, Cr, Ag, Ti, Ta, W, Pd and Pt.

57. The sensor element of claim 33, wherein the insulating layer is single-layered or multilayered and comprises one or more of Al₂O₃, AlN, SiO₂, and Si₃N₄.

58. The sensor element of claim 43, wherein the insulation is formed as a single layer or multilayer and comprises one or more of Al₂O₃, AlN, SiO₂, and Si₃N₄.

59. The sensor element of claim 43, wherein the insulation comprises oxides, nitrides, ceramics, glasses, or plastics as material.

60. The sensor element of claim 33, wherein the sensor element is designed for direct integration into a microelectromechanical systems (MEMS) structure, into a semiconductor-embedded-in-substrate (SESUB) structure, or both.

61. A method for manufacturing a sensor element for measuring a temperature, the method comprising:
providing a carrier material to form a carrier;
forming an insulating layer on a top side of the carrier;
applying at least one electrode to a partial area of the insulating layer so that an area of the insulating layer remains free of the at least one electrode;
applying at least one intermediate layer to the area of the insulating layer that is free of the at least one electrode material;
applying at least one functional layer to at least a partial area of a plane formed by the at least one electrode and the at least one intermediate layer;
applying at least one further electrode to a partial area of the at least one functional layer;
applying at least one further intermediate layer to a partial area of the functional layer that is free of the at least one further electrode;
structuring of at least one of the electrodes to form at least one trimmable area for adjustment of a resistance value of the sensor element; and
forming contact pads for electrical contacting of the sensor element.

62. The method of claim 61, further comprising setting the resistance value of the sensor element by trimming the at least one structured electrode.

63. The method of claim 61, further comprising the forming an insulation on at least a partial area of a surface of the sensor element.

64. The method of claim 61, further comprising forming at least one further intermediate layer between the contact pads and the at least one functional layer.
